(19) United States
(12) Patent Application Publication
(10) Pub. No.: US 2012/0262335 A1
(43) Pub. Date: Oct. 18, 2012

(54) Network coverage and demand maps

(75) Inventors: Alejandro R. Holcman, San Diego, CA (US); Manish Tripathi, San Diego, CA (US); Mukesh K. Mittal, San Diego, CA (US)

(73) Assignee: QUALCOMM Incorporated, San Diego, CA (US)

(21) Appl. No.: 13/329,146

(22) Filed: Dec. 16, 2011

Related U.S. Application Data
(60) Provisional application No. 61/475,911, filed on Apr. 15, 2011.

(51) Int. Cl. G01S 19/05; G01S 3/02; G01S 19/12

(52) U.S. Cl. 342/357.42; 342/357.49; 342/451

(57) ABSTRACT

Disclosed is an apparatus and method for pairing measurements and position estimate as an information pair from multiple mobile devices and reporting these information pairs to a server without over burdening the mobile device and without requiring the mobile devices to establish a new link. Also, disclosed is an apparatus and method for collecting these information pairs and compiling network maps based on the information pairs.

### CROSS-REFERENCE TO RELATED APPLICATIONS

This application claims the benefit of and priority under 35 U.S.C. §119(e) to U.S. Provisional Application No. 61/475,911, filed Apr. 15, 2011, titled “Network coverage and demand maps” and which is incorporated herein by reference.

### BACKGROUND

I. Field of the Invention

This disclosure relates generally to crowd sourcing information for compiling maps, and more specifically to communication of pairs of mobile measurements and position estimates without excessively taxing mobile device resources and to compiling network maps based on such information pairs.

II. Background

It is time consuming and expensive to obtain exact coverage maps of a network. Typically, network operators deploy specialized field teams to collect signal information including a measurement and a location, and then compile the information into coverage maps. Moreover, networks operators may have difficulty in accurately obtaining “demand maps” showing where data is consumed and the level or volume of consumption at various locations within a cell or sector. Demand maps are typically at the cell or sector level of granularity and may not be precise enough to identify data bottlenecking areas. If accurate data bottlenecking areas where known, a network operator could precisely place micro, pico or femto cell access points and Wi-Fi hotspots for supporting WAN offloading.

Therefore, a need exists for improved position dependent measurement maps.

### BRIEF SUMMARY

An apparatus and method for capturing measurements and estimated positions as information pairs, for reporting said information pairs without overly burdening a mobile device, and for crowd sourcing said information pairs into network maps are presented. A mobile device may obtain assistance data from a server located internally to or externally from the mobile radio network. Mobile devices regularly communicate with these position location assistance data servers (e.g., position determination entity or PDE) for the purposes of computing their location or to periodically update their position location assistance data. According to embodiments described herein, a mobile device may use its most previously estimated position as this rough position. At the time when the previously estimated position is first determined, the mobile device may record a measurement (e.g., serving network, network technology, network signal quality and signal strength indicators, sensor measurement or voice and data services measurement) that may be helpful to a network when aggregated with other position-measurement pairs with other mobile devices at different times and at various locations. Therefore, at the time of a position estimate is first determined, the mobile device also records a measurement. The mobile device optionally timestamps the measurement and position estimate pair with the current time. Therefore, the information pair contains at least one measurement and a position estimate. This information pair may be appended to a future request for assistance. The positioning server crowd sources this and similar information pairs then compiles network maps from the crowd sourced information. Using this method, the mobile device provides this information pair to the network without establishing a connection not already being established and the positing server may collect and compile these information pairs to produce various network maps.

According to some aspects, disclosed is a method in a mobile device for pairing a measurement to an estimated position as an information pair, wherein the mobile device operates in a mobile radio network, the method comprising: receiving positioning signals; computing the estimated position of a location based on the positioning signals; recording a measurement at the location; saving the position estimate and the measurement to memory; and sending a request for assistance data comprising the position estimate and the measurement.

According to some aspects, disclosed is a method in a server for collecting measurements and estimated positions as information pairs from a plurality of mobile devices operating in at least one mobile radio network, the method in the server comprising, for each mobile device: receiving a request for assistance data comprising a position estimate of a location and a measurement at the location; and saving the position estimate and the measurement as an information pair to a database.

According to some aspects, disclosed is a mobile device comprising a processor and memory, a sensor, a positioning receiver, a cellular transceiver, each coupled to the processor, wherein the memory comprises code for: receiving positioning signals from the positioning receiver; computing, in the processor, the estimated position of a location based on the positioning signals; recording, to the memory, a measurement at the location; saving the position estimate and the measurement to the memory as an information pair; and sending, with the cellular transceiver, a request for assistance data, wherein the request for assistance data comprises the position estimate and the measurement.

According to some aspects, disclosed is a mobile device, the device comprising: means for receiving positioning signals; means for computing the estimated position of a location based on the positioning signals; means for recording a measurement at the location; means for saving the position estimate and the measurement to memory; and means for sending a request for assistance data, wherein the request for assistance data comprises the position estimate and the measurement\

According to some aspects, disclosed is a computer-readable storage medium including non-transitory program code stored thereon, comprising program code for: receiving positioning signals; computing the estimated position of a location based on the positioning signals; recording a measurement at the location; saving the position estimate and the measurement to memory; and sending a request for assistance data, wherein the request for assistance data comprises the position estimate and the measurement.

According to some aspects, disclosed is a server for collecting measurements and estimated positions as information pairs from a plurality of mobile devices operating in at least one mobile radio network, the server comprising, for each mobile device: means for receiving a request for assistance data comprising a position estimate of a location and a measurement at the location; and means for saving the position estimate and the measurement as an information pair to a database.

According to some aspects, disclosed is a server comprising a processor and memory coupled to the processor, wherein the memory comprises code for: receiving a request for assistance data comprising a position estimate of a location and a measurement at the location; and saving the position estimate and the measurement as an information pair to a database.

According to some aspects, disclosed is a computer-readable storage medium including non-transitory program code stored thereon, comprising program code for: receiving a request for assistance data comprising a position estimate of a location and a measurement at the location; and saving the position estimate and the measurement as an information pair to a database.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWING

Embodiments of the invention will be described, by way of example only, with reference to the drawings.

FIG. 1 shows a mobile radio network with an internal positioning server.

FIG. 2 shows multiple mobile radio networks and an external positioning server, in accordance with some embodiments of the present invention.

FIG. 3 shows a method for a network server to obtain a measurement and an associated position estimate as an information pair, in accordance with some embodiments of the present invention.

FIGS. 4 and 5 show an improved method for a positioning server to obtain a measurement and an associated position estimate as an information pair, in accordance with some embodiments of the present invention.

FIG. 6 shows a method in a mobile device for pairing a measurement to an estimated position, wherein the mobile device operates in a mobile radio network, in accordance with some embodiments of the present invention.

FIG. 7 shows a method in a positioning server for collecting measurement and estimated position pairs from a plurality of mobile devices operating in at least one mobile radio network, in accordance with some embodiments of the present invention.

FIG. 8 illustrates a mobile device in block diagram form, in accordance with some embodiments of the present invention.

FIGS. 9-18 show different examples of a request for assistance data message, in accordance with some embodiments of the present invention.

FIGS. 19 and 20 show example maps, in accordance with some embodiments of the present invention.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

Position determination techniques described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, GLONASS or Compass may transmit a signal marked with a PN code that is distinguishable from PN codes transmitted by other SVs in the constellation (e.g., using different PN codes for each satellite as in GPS or using the same code on different frequencies as in GLONASS). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

As used herein, a mobile device 100, sometimes referred to as a mobile station (MS) or user equipment (UE), such as a cellular phone, mobile phone or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term mobile device is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, mobile device is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a mobile device 100.

Embodiments of the present invention utilize messaging a mobile radio is already sending to a positioning server. In some embodiments, a mobile device appends a measurement and position estimate pair as an information pair to an existing message, thereby avoiding an additional message exchange between the mobile device and the positioning server or other network entity. This information pair may be transmitted in one or more spots within, immediately before and/or immediately after the request for assistance data. The positioning server collects a number of similar information pairs from various mobile devices located throughout the network. Over time, crowd sourcing at the positioning server may provide sufficient data to generate a measurement map with finer granularity than at the cell or sector level, as described below.

In normal operations, a mobile device may estimate its position several times during a day. Each time the mobile device prepares to estimate its position, the mobile device may request assistance data from a positioning server within or outside the mobile radio network. Once the mobile device receives the assistance data, the mobile device uses the assistance data to help estimate a current position. According to embodiments of the present invention, a mobile device also captures and records a measurement at the time it estimates its position. The mobile device then saves this current position estimate along with the current measurement as an information pair to memory. Optionally, the information pair also contains a timestamp of when the measurement was taken or the position estimate was calculated. The measurement time and the position estimate time may be identical or roughly similar. The measurement by itself may have no or little value to the mobile device. That is, the mobile device may never need the measurement but is only capturing the measurement for the benefit of the positioning server.

The mobile device keeps this information pair if and until it sends another request for assistance data message to the positioning server. The positioning server, which provided the mobile device with assistance data, may be within a mobile radio network or may be outside of the mobile radio network. The positioning server may collect several information pairs from various mobile devices at various locations within one or more cells across the same or different mobile radio networks. The positioning server uses the information pairs to map the measurement to an estimate position. Some examples of measure maps may include maps of mobile obtained E_{c}/N₀, RSCP (received signal code power), RSSI (received signal strength), a volume or rate of data demanded by the mobile device, a volume of data services consumed by the mobile device, or number of calls made and/or received at a particular location. The positioning server may plot each measurement at its corresponding position estimate. Alternatively, the positioning server may place each corresponding position estimate into a sub-sector sized bin and plot the average measurements wherein each average represents the measurements within each bin. The positioning server may thereby create a measurement map having a granularity better than a cell or sector. The coverage maps, data demand maps and other maps may be generated via a post processing of the information pairs and may be used for improved network planning and deployment.

The cost to the mobile device is twofold and limited to: (1) capturing and saving a measurement once the mobile device has computed an estimated position for some other reason; and (2) append or otherwise supplement the request for assistance data with the bits necessary to report the saved measurement and optionally the measurement time along with the estimated position. The mobile radio network, however, is positively impacted far more than an individual mobile device is negatively impacted. The mobile radio network may now compile and produce previously unavailable coverage maps and data demand maps.

A request for assistance data message may include an information element for a rough position, however, the rough position may have been computed earlier with more accurate estimation (e.g., using GPS position location), which makes a captured measurement fixed to an accurate estimated position. This information pair is very valuable for map making and other applications. Previously, cell maps where created by special dedicated teams traversing an area or by recording measurements at a base station. Such measurements are often insufficient in measurement types, easily outdated, difficult to acquire, inaccurate and/or expensive to collect.

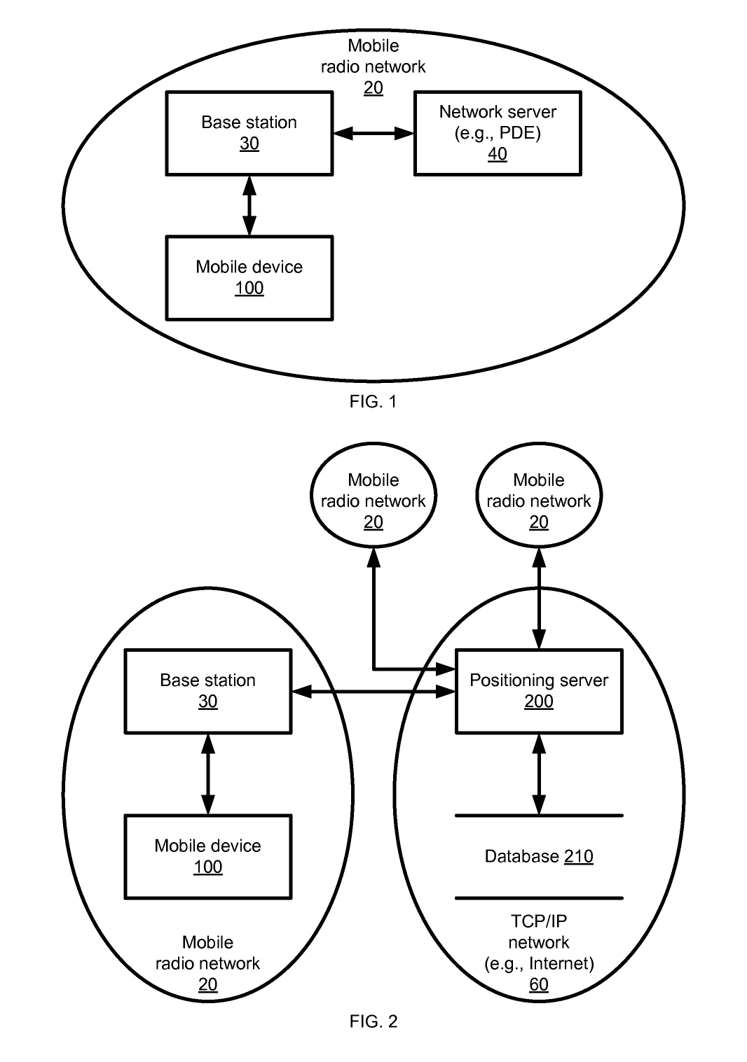

FIG. 1 shows a mobile radio network 20 with an internal positioning server (network server 40). The mobile radio network 20 also contains a base station 30. The base station 30 may be a BSS (base station subsystem), a BTS (base transceiver station), node-B, an access point, a picocell, a femtocell, or the like. In addition, the mobile radio network 20 contains one or more mobile devices 100. The network server 40 (e.g., a position determining entity or PDE) in mobile radio network 20 is located within and controlled by the mobile radio network 20. In existing networks, each mobile radio network 20 contains its separate network server 40.

Often a network server 40 may not be adaptable to new messaging protocols, for example, to modified requests for assistance data as described below. In this case, the network server 40 may be limited in flexibility and adaptability due to regulatory or network operator requirements and practices. A network server positioned outside the control of the mobile radio network 20 may provide the desired flexibility.

FIG. 2 shows multiple mobile radio networks 20 and a positioning server 200 external to the mobile radio networks 20, in accordance with some embodiments of the present invention. Each mobile radio network 20 contains base stations 30 and mobile devices 100. The mobile devices 100 are capable of accessing the positioning server 200, for example, through the IP network. In the case shown, mobile devices 100 from multiple mobile radio networks 20 may share a positioning server 200 located apart from and out of the control of the mobile radio networks 20. In some cases, a mobile device 100 residing in a mobile radio network 20 accesses a common positioning server 200 located outside of the mobile radio network 20 via a TCP/IP network 60 (e.g., the Internet) or similar cloud. In this manner, the positioning server 200 acts as another address on the Internet and a mobile radio network 20 only needs to provide a generic Internet access connection between the mobile device 100 and positioning server 200.

The positioning server 200 may function as a replacement to or may supplement a network server 40 (e.g., a network PDE). The positioning server 200 is shown coupled to a database 210, which may be internal, collocated with, external to or remote from the positioning server 200. The database 210 contains assistance data including one or both of a base station almanac and a satellite almanac.

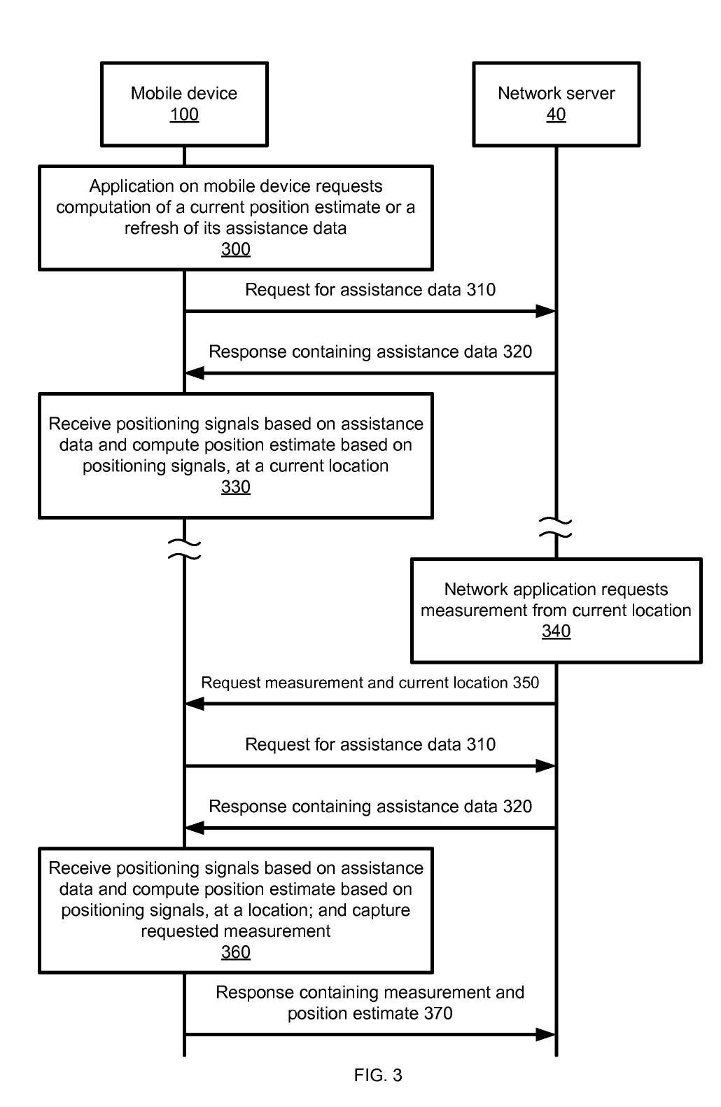

FIG. 3 shows a method for a network server to obtain a measurement and an associated position estimate as an information pair, in accordance with some embodiments of the present invention. The figure shows communication between a mobile device 100 and an internal network server 40. When a mobile device 100 determines or is instructed to determine a position estimate based on positioning signals, it communicates with the internal network server 40. For example, at step 300, an application on the mobile device 100 requests the mobile device 100 to compute a current position estimate. The mobile device 100 sends a request for assistance data message 310 to the internal network server 40. In response, the network server 40 sends a response message 320 containing assistance data. At step 330, the mobile device 10 receives the response message 320 and begins to receive certain position signals based on the assistance data. For example, the assistance data tells the mobile device 100 what positioning satellites are visible and what parameters are necessary to quickly lock and receive positioning signals from positioning satellites and/or signals from base stations. Based on these positioning signals, the mobile device 100 computes a position estimate at a current location. This position estimate is then passed to the application requesting computation of the current position estimate. Time may pass where no position estimates are requested or computed, as indicated in the figure with the breaking lines.

At step 340, a network application requests measurements from a current location of the mobile device 100. For example, the measurement request may be a request for received signal quality, a received signal strength indicator (RSSI) or a bit error rate (BER). The network server 40 sends a request message 350 for a mobile measurement and a current location. The mobile device 100 receives the request message 350 and in turn sends a second request for assistance data message 310 to the network server 40. In response, the network server 40 sends a response message 320 containing assistance data.

At step 360, the mobile device 100 receives the response message 320 containing the assistance data and begins to receive certain signals indicated in the assistance data. The mobile device 100 also captures the requested measurement and computes the position estimate. Next, the art mobile device 100 sends a response message 370 that contains both the requested measurement and where the measurement was captured.

The above-described scenario uses a mobile device 100 and requires extra traffic on the air interface. This extra traffic includes a request for assistance data message 310, a response message 320, and the response message 370, all shown on the second half of the figure. In accordance with embodiments of the present invention, scenarios below eliminate or reduce the air interface traffic to messages exchanged for another purposes (e.g., requesting assistance data).

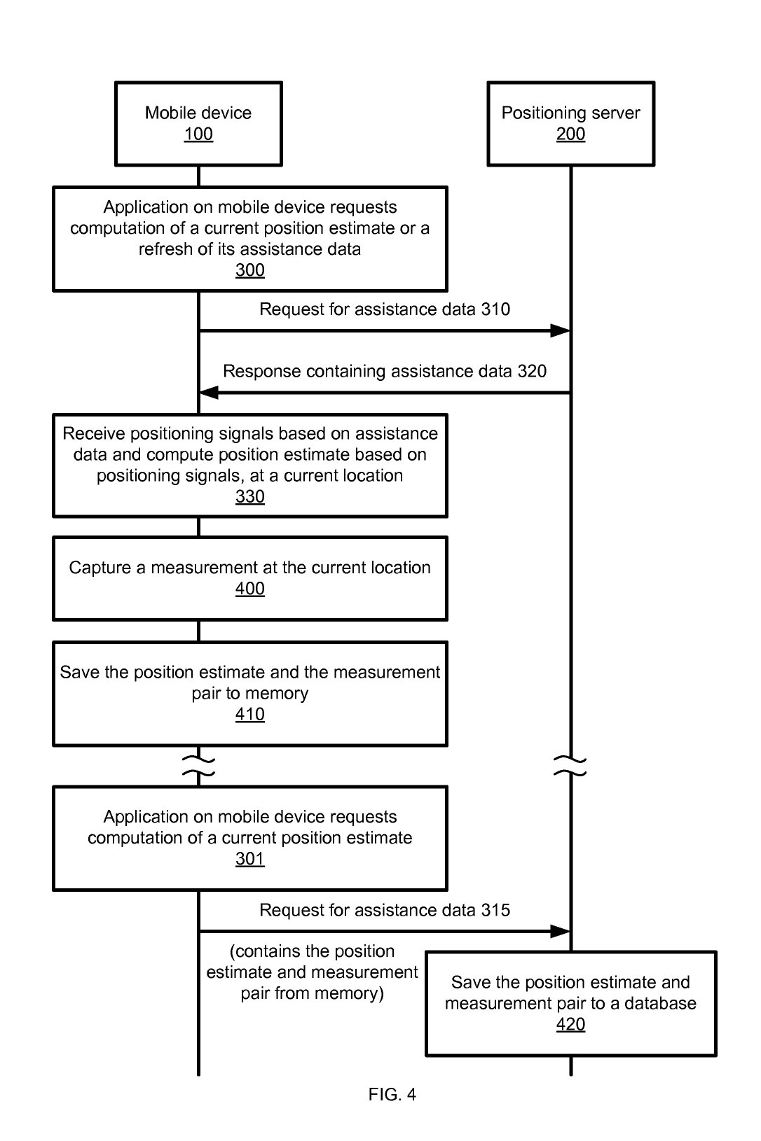

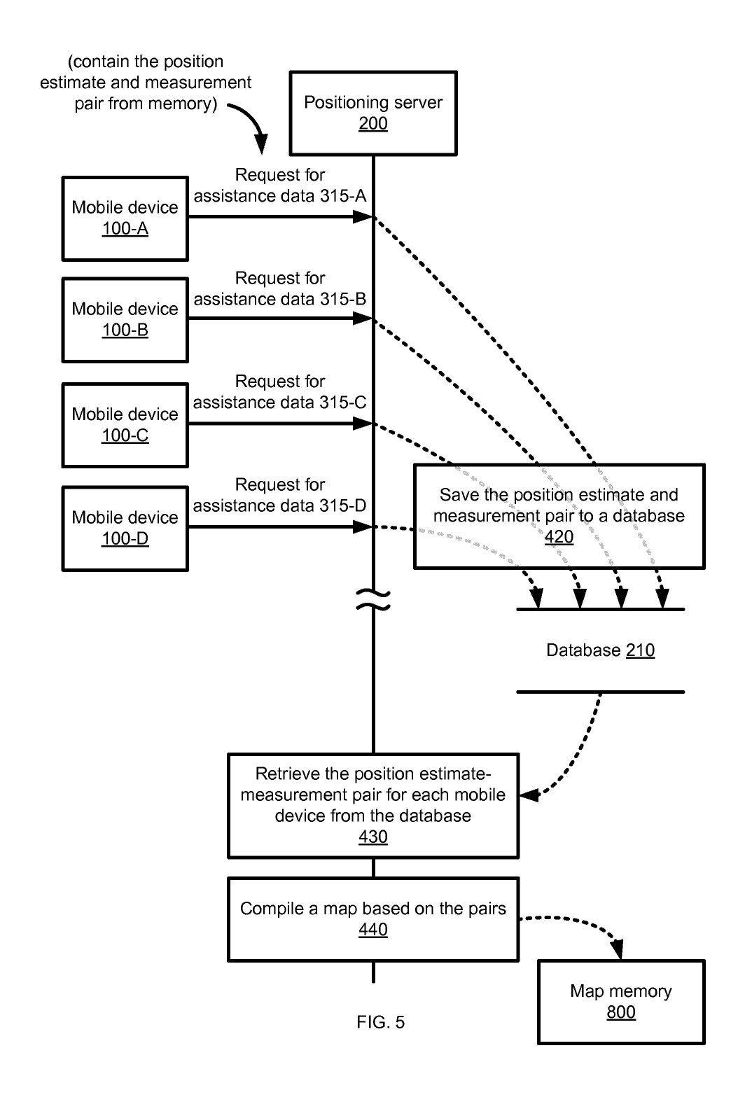

FIGS. 4 and 5 show an improved method for a positioning server 200 to obtain a measurement and an associated position estimate as an information pair, in accordance with some embodiments of the present invention.

In FIG. 4, a mobile device 100 piggybacks measurement information useful to a positioning server 200 to a request it is already sending. Unlike the extra message exchange described above, the current method minimizes extra traffic at the cost of sending measurements and position estimates that are stale, outdated, historic or old. The age of the information pairs, however, is independent to the value of the information pairs in creating various network maps.

At step 300, an application on a mobile device 100 requests that the mobile device 100 computes a current position estimate. This request is independent from any desire for a position estimate from a network map making entity. The mobile device 100 sends a request for assistance data message 310 to the network server 40. In some cases, the mobile device 100 may not have a prior position estimate to use as a seed position and may not have a corresponding measurement saved as an information pair. In these cases, the mobile device 100 may attach an identifier (such as a cell identifier and/or a sector ID, or the like) to the request for assistance data message 310. The identifier acts as a coarse position estimate or a seed position that the positioning server 200 may use to compile the appropriate assistance data. The mobile device 100 may also periodically refresh its assistance data by instigating step 300 at regular intervals.

In response, the positioning server 200 sends a response message 320 containing the appropriate assistance data. The mobile device 100 receives the response message 320 and at step 330, begins to receive certain position signals based on the assistance data. The positioning signals may be from satellites, pseudo-lites, base stations, access points, or other transmitters. Based on these positioning signals, the mobile device 100 computes a position estimate at a current location. This position estimate is then passed to the application requesting computation of the current position estimate.

At step 400, the mobile device 100 performs an anticipatory step of capturing a measurement at the current location in the hopes that the information pair (i.e., estimated position and corresponding measurement). The measurement may be a cell identifier (such as a Cell ID, LAC, MNC and/or MCC or the like). The measurement may be a characteristic of one or more cells. The cells may be a currently severing cell, a neighboring cells, and/or another detected cells within the same network or another network. The measurement may be an IP address such as an address of streaming content or a downloaded object, such as a song, video or executable file. The measurement may be from a sensor or multiple sensors on the mobile device 100. For example, the measurement may be from a light sensor, a camera, a microphone and/or sound level sensor. The measurement may be a signal strength and/or signal quality. The measurement may be an inertial measurement and/or a magnetometer reading. The measurement may be a barometric pressure and/or a temperature. The measurement may be a measurement of uplink and/or downlink traffic communicated over a previous period. For example, the measurement may be an amount or volume of downlink traffic in the previous period where the previous period is a set duration such as 10, 30 or 60 minute or a set number of hours. The measurement may be a count of phone calls (incoming and/or outgoing) and/or a number of minutes of talk time used during a previous period (e.g., a number of incoming minutes used and/or a number of outgoing minutes used). The measurement may be from a single sensor or may comprise measurements from a plurality of sensors, such as one or any combination of these examples of measurements.

In some embodiments, the measurement is a value already obtainable or known by the mobile radio network 20. In these cases, there would be no need for a network server 40 to request this measurement, however, the positioning server 200 may not have access to the information known to the mobile radio network 20. For example, the mobile radio network 20 already tracks incoming and outgoing voice and data usage. Therefore, it is counter intuitive for a mobile device 100 to record these measurements and later send them in a request for assistance data message. Advantageously, in these embodiments, a positioning server 200 may be distinct and separate from the mobile radio network 20, such that the positioning server 200 may obtain network related measurements without communicating directly with the network-side of the mobile radio network 20. Instead, the mobile radio network 20 provides a pipeline (e.g., TCP/IP gateway) between the mobile device 100 and the positioning server 200.

In other embodiments, the measurement is a value best obtained by the mobile device 100. In yet other embodiments, the measurement is obtainable by the mobile device 100 and not obtainable directly from the network-side of the mobile radio network 20 without new communications with the mobile device 100. For example, only the mobile device 100 may determine a signal level, signal quality, sound level, light level, temperature, pressure, magnetic measurement or similar local measurement at the mobile device 100. In these cases, the mobile device 100 acts as a remote sensor.

Referring back to FIG. 4, at step 410, the mobile device 100 saves the position estimate and the measurement as an information pair to memory. This information pair is not necessarily saved in adjoining memory. This information pair may be linked or otherwise placed in a table of similar information pairs. The pair is saved for future compilation into maps by the positioning server 200.

The mobile device 100 may loop performing step 330 (computing a position estimate at a then current location), step 400 (recording a measurement at the then current location) and step 410 (saving the new position estimate and the measurement as an information pair to memory). In this manner, the mobile device 100 makes a single request-response exchange (messages 310 and 320), then loops at computing new a position estimate, recording a new measurement and saving the pair to memory.

Time may pass where no position estimates are computed, as indicated in the figure with the breaking lines. The mobile device 100 may have travelled a long distance from the position the previous measurement was taken and paired to the then current position estimate. After this time, the same or another application may require a new position estimate or a periodic update to the assistance data. At step 301, an application on a mobile device 100 requests the mobile device 100 to compute a current position estimate. If fresh assistance data is needed, the mobile device 100 begins a process to obtain new assistance data, however, the mobile device 100 now has at least one measurement and an associate position estimate (or multiple measurement/position estimate pairs) that it saved earlier in anticipation of the following exchange.

A subsequent request for assistance data message 315 contains a location for a seed position or previous position estimate. In this case, the mobile device 100 has a previously computed and saved a position estimate (e.g., from step 410). The mobile device 100 may now insert the saved position estimate in the next request for assistance data message 315 as the seed position. The mobile device 100 may also piggyback and insert the corresponding saved measurement in the request for assistance data message 315. The mobile device 100 sends the request for assistance data message 315 to the positioning server 200. The positioning server 200 received the request for assistance data message 315 containing the position estimate and the measurement as an information pair and responds with a response message 320 as described above. The previous request for assistance data message 310 described earlier may also contain one or more information pairs similar to this subsequent request for assistance data message 315. In any case, an information pair placed in a request message 310 or 315 contains a position estimate (and corresponding measurement) that is not current but still useful to a positioning server 200 as part of crowd sourcing information into network maps.

At step 420, the positioning server 200 saves the position estimate and the measurement pair to a database, and collects similar information pairs from multiple other mobile devices 100. In this manner, the positioning server 200 develops a database that may be organized into a location-measurement map. For example, if the measurement is a user data usage measurement, then the map may show densities of high, medium and low user data usage with resolution of a subarea (sub-cell or sub-sector) typically unavailable to a network.

In FIG. 5, multiple mobile devices 100 are shown (mobile device 100-A, mobile device 100-B, mobile device 100-C, and mobile device 100-D) each communicating a corresponding request for assistance data message 315 (message 315-A, message 315-B, message 315-C, and message 315-D). Some, many or all of the request for assistance data messages 315 contain a position estimate and measurement as an information pair from a previous position computation. As described above, the information pair comprises a measurement that corresponds to a time and place of a previous position fix. At step 420, the positioning server 200 saves the information pairs to a database 210. In this manner, the positioning server 200 crowd sources information pairs from multiple mobile devices 100 across a network, throughout a cell, and over a substantial period of time, which may be hours, days, weeks or longer, as indicated in the figure with the breaking lines. The mobile devices 100 may all be from a single mobile radio network 20 or from multiple different or unrelated mobile radio networks 20.

At step 430, the positioning server 200 or a server or process able to access the database 210, retrieves the position estimate-measurement pairs as information pairs from the multiple mobile devices 100 and at step 440, compiles a map based on the information pairs. The map or maps may be saved to a map memory 800 or future access.

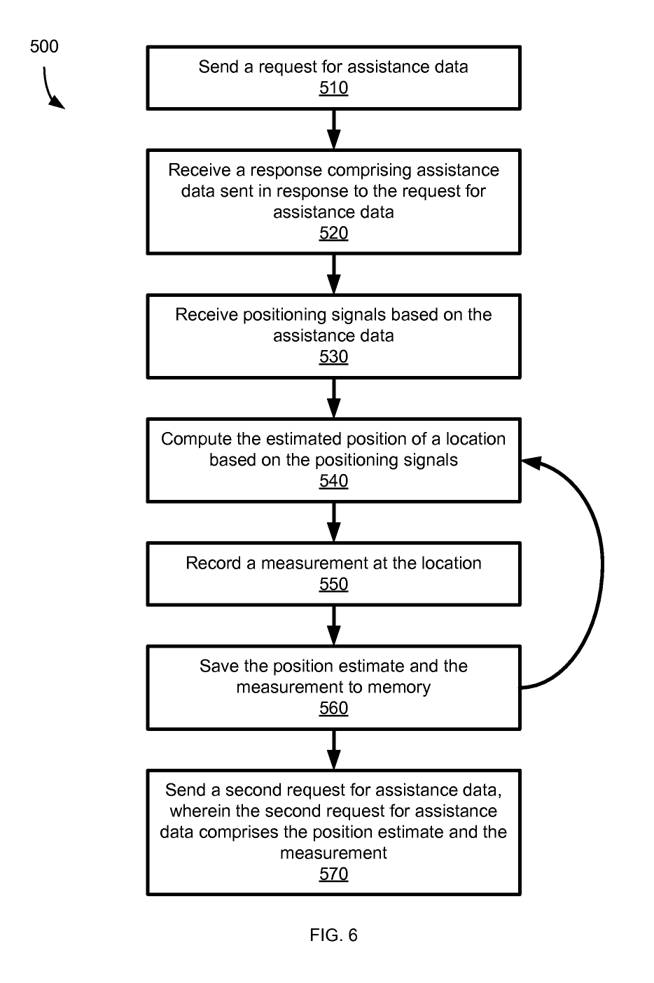

FIG. 6 shows a method 500 in a mobile device 100 for pairing a measurement to an estimated position, wherein the mobile device 100 operates in a mobile radio network 20, in accordance with some embodiments of the present invention.

If the assistance data within the mobile device 100 is good enough, the mobile device 100 may skip step 510 and step 520 and proceed to step 530. When the assistance data is insufficient, the mobile device 100 may begin with step 510. At step 510, the mobile device 100 sends a request for assistance data. At step 520, the mobile device 100 receives a response with the assistance data sent in response to the requested for assistance data. At step 530, the mobile device 100 uses the assistance data to receive positioning signals. At step 540, the mobile device 100 computes an estimated position of the current location of the mobile device 100 based on the received positioning signals. At step 550, the mobile device 100 also records a measurement at the current location.

Measurements may represent a value at a point in time (e.g., a signal strength measurement) or an accumulated value (e.g., number of data packets sent in the last period) and measurements may be taken just after, just before or during a position estimate. In some embodiments, multiple measurements are captured. For example, a first measurement may be a temperature and a second measurement may be a barometric pressure both associated with the current location and the position estimate. In other embodiments, a measurement may be tallied. For example, a measurement may be from a counter or summer, which is increment each time another call is conducted or a block of data is transferred.

At step 560, the mobile device 100 saves the position estimate and the measurement to memory as an information pair. The information pair represents a measurement that occurred at the position estimate. The information pair may also be associated with a time. That is, at approximately the same time, the mobile device 100 captured the measurement and computed the position estimate.

Sometime in the future unassociated with step 510, an application may require another position estimate. At this point, the mobile device 100 contains a saved information pair that it may send to the positioning server 200. At step 570, the mobile device 100 sends a subsequent or second request for assistance data. This second request contains the position estimate and the measurement and possibly the timestamp of the information pair. The prior request for assistance data at step 510 might or might not contain an information pair from a previous position estimate and measurement. In some embodiments, the first position estimate acquired at steps 530 and 540 is performed without sending a previous request for assistance data. In other words, a first position estimate is found through known means (e.g., scanning for known GPS satellites, trilateration or triangulation) and does not use assistance data. The method 500 may continue and repeat steps 540 through 560 saving a new information pair to memory each time as shown with the feedback arrow. The method 500 may also begin again at step 510 when the assistance data becomes inadequate.

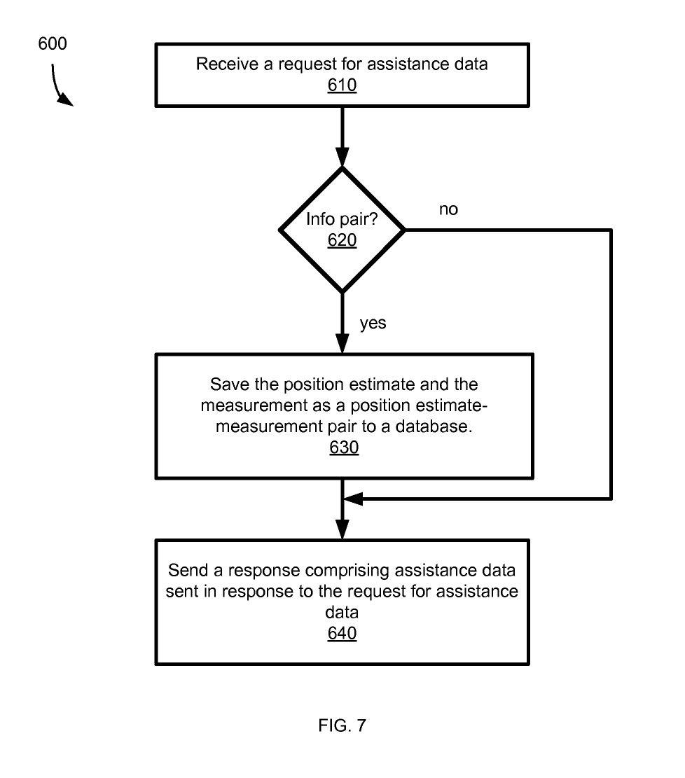

FIG. 7 shows a method 600 in a positioning server 200 for collecting measurements and estimated positions as information pairs from a plurality of mobile devices 100 operating in at least one mobile radio network 20, in accordance with some embodiments of the present invention.

At 610, the positioning server 200 receives a request for assistance data. The request may or may not contain a measurement and position estimate as an information pair. At step 620, the positioning server 200 determines whether the request for assistance data contains an information pair. The information pair does not necessarily mean only two pieces of data are included in the “pair.” The key pair of information (i.e., a measurement and its position estimate) may be supplemented with addition information such as a timestamp the measurement was taken. That is, the information pair means that an estimated position of a location is paired with one or more measurements that were captured at that location.

If the request for assistance data contains no information pair, processing continues at step 640. If the request for assistance data contains an information pair, processing continues at step 630. At step 630, the positioning server 200 saves the position estimate and the measurement as a position estimate-measurement pair or an information pair to a database (e.g., database 210). The information pair represents information of at common location and a common time. Next at step 640, the positioning server 200 sends a response including the assistance data, which is sent in response to the request at step 610.

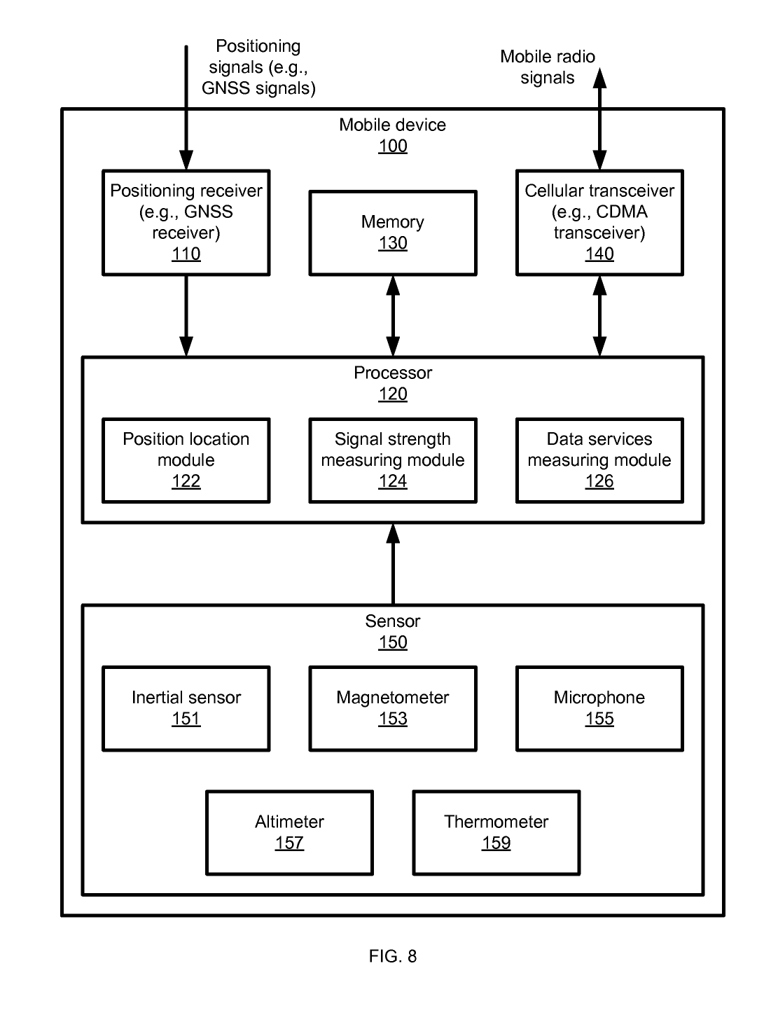

FIG. 8 illustrates a mobile device 100 in block diagram form, in accordance with some embodiments of the present invention. The mobile device 100 includes a positioning receiver 110, a processor 120, memory 130, a cellular transceiver 140 and a sensor 150. The positioning receiver 110 may include a GNSS receiver, such as a GPS receiver.

The processor 120 includes a position location module 122 to accept signals from the positioning receiver 110 and/or mobile radio signals from the cellular transceiver 140, and to compute a position estimate. The processor 120 may also include a signal strength measuring module 124 and/or a signal quality measuring module (not shown). The processor 120 may also include a data services measuring module 126 to measure a volume of user data consumed on a downlink and/or produced on an uplink, over a defined period. For example, the number of kilobytes received from a web service over a previous one minute or other predetermined duration of time.

The sensor 150 may include one or more of: (1) an inertial sensor 151 (e.g., an accelerometer and/or a gyroscope); (2) a magnetometer 153; (3) a microphone 155; (4) an altimeter 157; and/or (5) a thermometer 159, as some examples. Alternatively, or in addition to, the sensor 150 may contain one or more other sensors or sensor modules as well, such as: (1) a camera; (2) light sensor; (3) impact sensor, and so on. The mobile device 100 may also contain other receivers and transceivers, such as a Wi-Fi transceiver (not shown). Each of the sensors and sensor modules is coupled to provide a measurement to the processor 120.

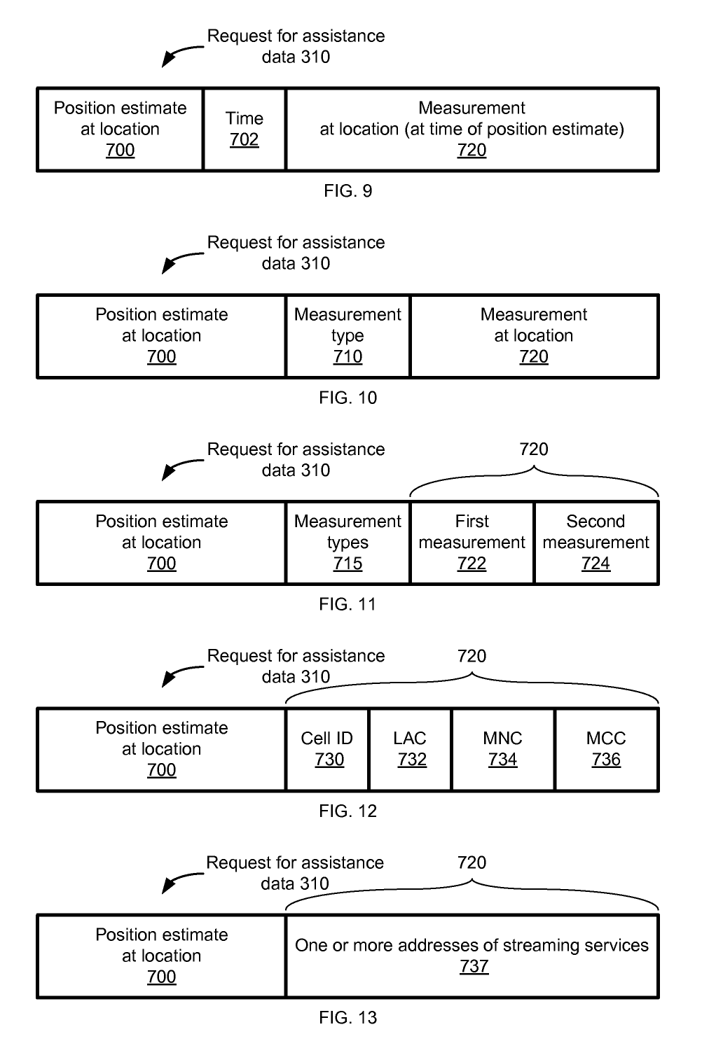

FIGS. 9-18 show different examples of a request for assistance data message, in accordance with some embodiments of the present invention. These various examples may be combined and parsed such that any combination of elements is realized. In each of the figures, a request for assistance data message 310 contains a position estimate at some location. Due to motion of the mobile device 100, the location where the mobile device 100 computed its originally position estimate may no longer be the current location of the mobile device 100. That is, the position estimate may be from a location that no longer acts as a viable seed to the positioning server 200 in finding the best assistance data.

The messages contain a request for assistance data header, a position estimate 700, a time 702 and a measurement 720. The position estimate 700 may be a seed location of a standard request or may be in addition to a seed location. The time 702 represents the time that the position estimate 700 was computed and/or the measurement 720 taken or captured. The time 702 is not necessary but may be helpful for creating time-based measurement-position maps (e.g., a map representing measurements for various mobile radio positions uses during a morning commute).

FIG. 9 shows a generic measurement 720 captured at the same location and time represented by the position estimate 700. It contains a position estimate 700, a time 702, and a measurement 720. This message format allows a positioning server 200 to create time-based measurement maps.

FIG. 10 shows another generic request for assistance data 310 that contains a measurement type 710 and a measurement 720 associated with the position estimate 700 and measurement type 710. This message format allows for reporting of different types of measurements 720.

FIG. 11 shows another generic request for assistance data 310 that contains measurement type field 715 and multiple measurements 720 (e.g., a first measurement 722 and a second measurement 724). This message format allows for a variable or a fixed number of messages types to be communicated.

FIG. 12 shows specific request for assistance data 310 that contains a position estimate 700 and multiple measurements 720 (e.g., Cell ID 730, a LAC 732, a MNC 734 and a MCC 736). Here, the measurements are values interpreted from an overhead message decoded from mobile radio signals received by a cellular transceiver 140.

FIG. 13 shows a specific request for assistance data 310 where the request contains a position estimate 700 and one or more addresses of streaming services 737. The measurements may be measurements in the form of Internet protocol (IP) network addresses, such as one or more URLs or addresses of frequently used or currently used streaming services. A network may make a map of popular content using the addresses of the streaming services 737. Similarly, the addresses may represent a fixed length file such as a song or video or executable file or frequently-used or currently used server addresses that Applications may use. With such position estimates and addresses, a network operator may better know where to place a cache containing such streams and content.

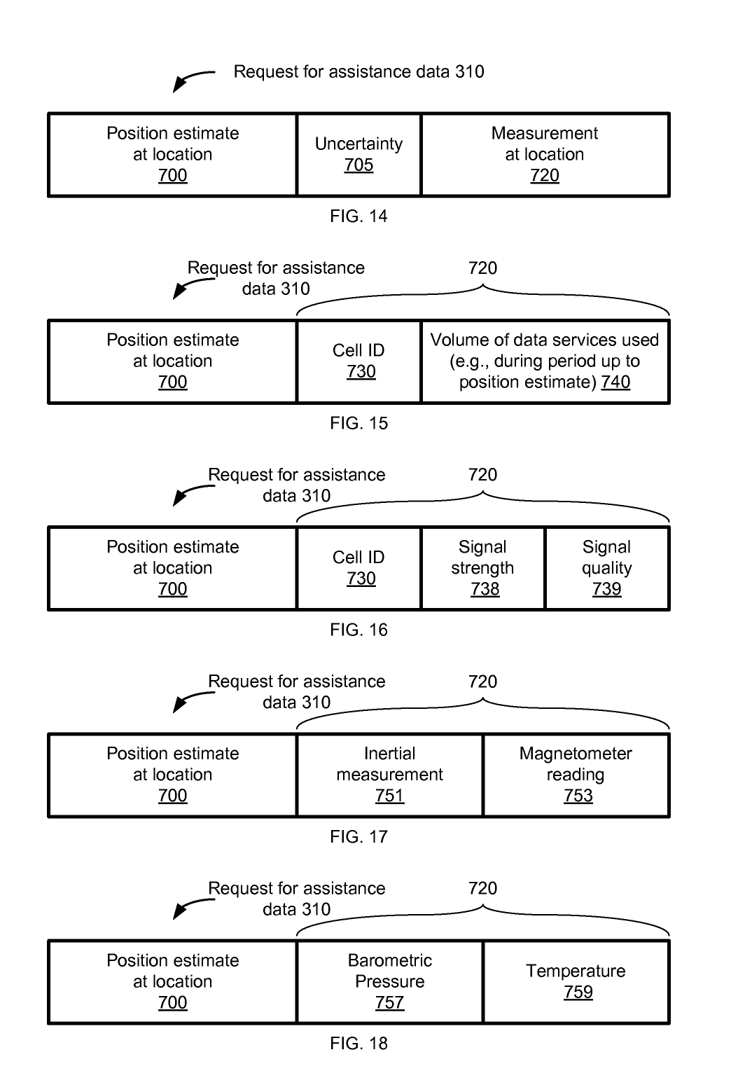

FIG. 14 shows generic request for assistance data 310 that contains position estimate 700, an uncertainty 705 of the position estimate, and a measurement 720. This message format allows for a mapping program to weight the various measurements 720 by using an inverse of the uncertainty 705. This message may contain other general elements as well (e.g., information elements included in a generic assistance data request message). Also, the message may contain additional information pairs. For example, if the mobile device 100 computed multiple position estimates and captured corresponding measurements without communicating these information pairs to a positioning server 200, the mobile device 100 may piggyback multiple information pairs in its request for assistance data.

FIG. 15 shows a specific request for assistance data 310 that contains a position estimate 700, a cell ID 730, and a volume of data services 740 consumed and produced by the mobile device 100 (e.g., a volume of data services used during a period of time up until the position estimate). Furthermore, the measurement could indicate if the mobile device 100 had to wait, perform extra buffering or request retransmission of this user data. A map created from this data may be used by a network operator to determine where a new base station or access point would best serve the network.

FIG. 16 shows a specific request for assistance data 310 that contains a position estimate 700, a cell ID 730, a signal strength 738 and a signal quality 739. Such information is useful for creating a detailed network coverage map.

FIG. 17 shows a specific request for assistance data 310 that contains a position estimate 700, an inertial measurement 751 and a magnetometer reading 753. Such information is useful for creating a detailed traveling or magneto map.

FIG. 18 shows a specific request for assistance data 310 that contains a position estimate 700, a barometric pressure 757 and a temperature 759. Such information is useful for creating a micro climate map.

Furthermore, the measurement may contain mobile radio network technology type (e.g., CDMA, TDMA, CDMA2000, 3GPP CDMA, Wi-Fi, IEEE 82.11x) or a cell type (e.g., WAN, LAN, cellular, access point). Additionally, the measurement may be communicated via a WAN network (e.g., cellular radio network) but regarding a LAN network (e.g., Wi-Fi hotspot), or via versa.

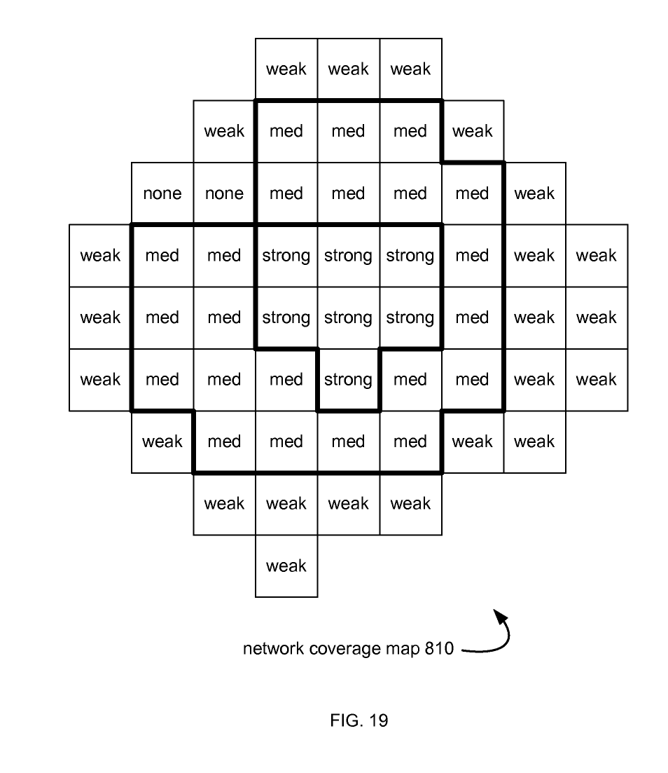

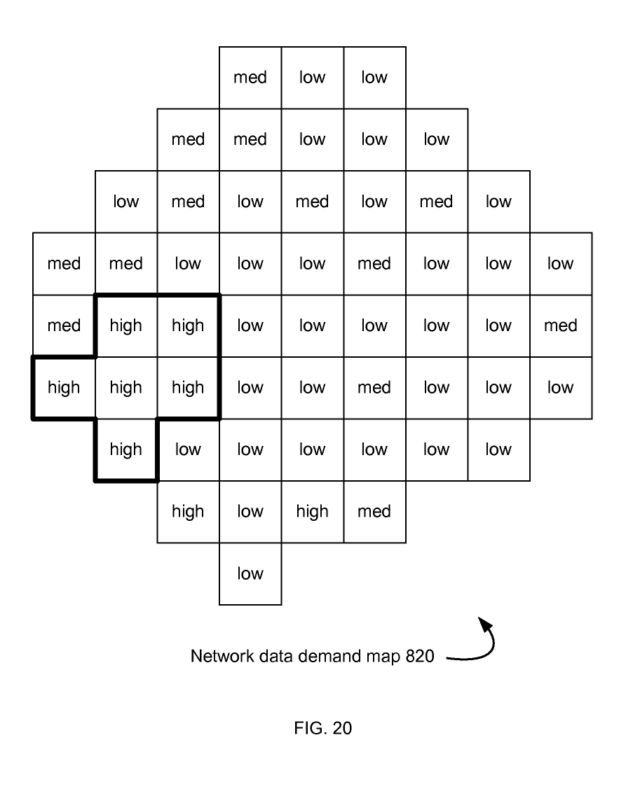

FIGS. 19 and 20 show example maps, in accordance with some embodiments of the present invention.

As described above, the positioning server 200 may crowd source the information pairs to compile one or more network maps. For example, mobile devices 100 measure and report a volume of data services consumed at a particular location, and the server compiles this information from the multiple mobile devices 100 to form network data usage maps, which may be used by a network operator to show when and where a network cell is busiest.

Using this method, the mobile device 100 may provide this information pair via the mobile radio network 20 using a connection established for a difference purpose. Similarly, the network server 40 or positioning server 200 may collect and compile this information from a number of mobile devices 100 in order to produce network maps.

FIG. 19 shows a network coverage map 810 containing a single cell and quantized signal strength and/or quality measurements for regions within the cell (for example from FIG. 16). In this example, the strongest and/or highest quality signals are near the center. The next range of medium strength signals forms a ring around the strongest signals and the weakest signals are in regions around the medium strength signals farther from the center. In analyzing this example network coverage map 810, a network operator, analyst or cell planner might notice in the north-west corner no signals are found when the cell planner expects at least weak signals. In the way, the network coverage map 810 may highlight coverage holes, locations of dropped calls, or areas needing a new microcell.

FIG. 20 show a network data demand map 820, for example, compiled from the request of FIG. 15. Such a map could be used to identify regions in a cell needing additional bandwidth. For example, this network data demand map 820 shows an area along the western edge of the cell that a high level of network demand occurs. A network planner may elected to install a Wi-Fi node or access point to provide additional data coverage to this area while also offloading the cell from the burden of carrying this high volume of traffic.

Described above a positioning server 200 provides assistance data, collects information pairs from request messages, and creates network maps. Such a positioning server 200 may be comprised of a first server to process assistance data messaging and a second server to generate network maps. These servers may be co-located or remotely located from each other but both with access to a common database 210.

Also described above is a positioning server 200 that communicates with mobile devices 100 that are all in a single mobile radio network 20 or alternatively that are in distinct mobile radio networks 20. A mobile device 100 may indicate which mobile radio network 20 is currently serving that mobile device 100. In this case, a positioning server 200 may create maps that compare, contrast or separate measurements from a first mobile radio network 20 and measurements from a second mobile radio network 20.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

What is claimed is:

1. A method in a mobile device for pairing a measurement to an estimated position as an information pair, wherein the mobile device operates in a mobile radio network, the method comprising:
receiving positioning signals;
computing the estimated position of a location based on the positioning signals;
recording a measurement at the location;
saving the position estimate and the measurement to memory; and
sending a request for assistance data comprising the position estimate and the measurement.

2. The method of claim 1, further comprising:
sending an initial request for assistance data; and
receiving an initial response comprising assistance data sent in response to the initial request for assistance data;
wherein receiving the positioning signals comprises receiving the positioning signals based on the assistance data; and
wherein the request for assistance data comprising a subsequent request for assistance data communicated after the initial request for assistance data.

3. The method of claim 1, wherein sending the request for assistance data comprises sending the request for assistance data to a server external from the mobile radio network.

4. The method of claim 1, wherein the request for assistance data comprises a previous position estimate and a previous measurement both from a previous location.

5. The method of claim 1, wherein the assistance data comprises terrestrial assistance data.

6. The method of claim 1, wherein a first request-response session comprises sending an initial request for assistance data and receiving an initial response, and wherein a second request-response session comprises sending the request for assistance data and receiving the response.

7. The method of claim 1, wherein the positioning signals comprise GNSS signals.

8. The method of claim 1, wherein the measurement comprises a signal strength indicator, signal quality indicator and a cell identifier.

9. The method of claim 1, wherein the measurement comprises a volume of data services on an uplink sent by the mobile device.

10. The method of claim 1, wherein the measurement comprises a volume of data services on a downlink received by the mobile device.

11. The method of claim 1, wherein the measurement comprises a volume of data services over a set duration of time.

12. The method of claim 1, wherein the measurement comprises number of calls over a set duration.

13. The method of claim 1, wherein the measurement comprises a sensor measurement from a sensor associated with the mobile device.

14. The method of claim 13, wherein the sensor comprises an inertia sensor and the sensor measurement comprises an indicator of an inertia sensor measurement.

15. The method of claim 13, wherein the sensor comprises a magnetometer and the sensor measurement comprises a magnetometer reading.

16. The method of claim 13, wherein the sensor comprises a microphone and the sensor measurement comprises a sound level.

17. The method of claim 13, wherein the sensor comprises an altimeter and the sensor measurement comprises a barometric pressure indicator.

18. The method of claim 13, wherein the sensor comprises a thermometer and the sensor measurement comprises a temperature.

19. The method of claim 1, wherein the request for assistance data further comprises a current cell identifier providing service to the mobile device.

20. The method of claim 1, wherein the request for assistance data further comprises a current network identifier providing service to the mobile device.

21. The method of claim 1, wherein the request for assistance data further comprises a frequency band the network is providing service to the mobile device.

22. The method of claim 1, wherein the request for assistance data further comprises a time receiving the positioning signals and recording the measurement.

23. The method of claim 1, wherein the request for assistance data further comprises an address of a data server the mobile device was interacting with.

24. The method of claim 1, wherein the request for assistance data further comprises an address of a streaming service provided to the mobile device.

25. The method of claim 1, wherein:
the request for assistance data further comprises at least two of:
a cell identifier;
a network identifier;
a signal quality indicator of the cell;
a signal strength indicator of the cell; and
the measurement comprises at least two of:
a volume of data services over a set duration of time;
a number of calls over a set duration;
an inertia sensor measurement;
a magnetometer reading;
a sound level;
a barometric pressure indicator; and
a temperature.

26. A method in a server for collecting measurements and estimated positions as information pairs from a plurality of mobile devices operating in at least one mobile radio network, the method in the server comprising, for each mobile device:
receiving a request for assistance data comprising a position estimate of a location and a measurement at the location; and
saving the position estimate and the measurement as an information pair to a database.

27. The method of claim 26, wherein the server is external from the at least one mobile radio network.

28. The method of claim 26, wherein the plurality of mobile devices comprise mobile devices operating in at least two mobile radio network.

29. The method of claim 26, wherein the request for assistance data comprises a previous position estimate and a previous measurement both from a previous location.

30. The method of claim 26, wherein the assistance data comprises terrestrial assistance data.

31. The method of claim 26, wherein a first request-response session comprises receiving an initial request for assistance data and sending an initial response, and wherein a subsequent request-response session comprises receiving the request for assistance data and sending the response.

32. The method of claim 26, wherein the measurement comprises a signal strength indicator, signal quality indicator and a cell identifier.

33. The method of claim 26, wherein the measurement comprises a volume of data services on an uplink sent by the mobile device.

34. The method of claim 26, wherein the measurement comprises a volume of data services on a downlink received by the mobile device.

35. The method of claim 26, wherein the measurement comprises a mobile radio network technology type.

36. The method of claim 26, wherein the measurement comprises a cell type.

37. The method of claim 26, wherein the measurement comprises a volume of data services over a set duration of time.

38. The method of claim 26, wherein the measurement comprises number of calls over a set duration.

39. The method of claim 26, wherein the measurement comprises a sensor measurement from a sensor in the mobile device.

40. The method of claim 39, wherein the sensor comprises an inertia sensor and the sensor measurement comprises an indicator of an inertia sensor measurement.

41. The method of claim 39, wherein the sensor comprises a magnetometer and the sensor measurement comprises a magnetometer reading.

42. The method of claim 39, wherein the sensor comprises a microphone and the sensor measurement comprises a sound level.

43. The method of claim 39, wherein the sensor comprises an altimeter and the sensor measurement comprises a barometric pressure.

44. The method of claim 26, further comprising, for each mobile device, discarding identifying information before saving the information pair to the database.

45. The method of claim 26, further comprising:
retrieving the information pair for each mobile device from the database as pairs; and
compiling a map based on the information pairs.

46. The method of claim 45, wherein the map comprises a map based on time.

47. The method of claim 45, wherein the map comprises a network coverage map based on location verses signal strength and quality.

48. The method of claim 47, wherein the network coverage map identifies holes in cell coverage.

49. The method of claim 45, wherein the map comprises a network data demand map based on location verses data volume.

50. The method of claim 49, wherein the network data demand map identifies areas of data services usage higher than a threshold.

51. The method of claim 45, wherein the map comprises a network voice demand map based on location verses number of calls.

52. The method of claim 49, wherein the network voice call demand map identifies areas of voice services usage higher than a threshold.

53. The method of claim 45, wherein the map plots location verses a sensor measurement from a sensor.

54. The method of claim 53, furthermore:
wherein the sensor comprises an inertia sensor;
wherein the sensor measurement comprises an indicator of an inertia sensor measurement; and
wherein the map comprises a mobility map.

55. The method of claim 53, furthermore:
wherein the sensor comprises a magnetometer;
wherein the sensor measurement comprises a magnetometer reading; and
wherein the map comprises a fine-scale magnetic map.

56. The method of claim 53, furthermore:
wherein the sensor comprises a microphone;
wherein the sensor measurement comprises a sound level; and
wherein the map comprises a sound level map.

57. The method of claim 53, furthermore:
wherein the sensor comprises an altimeter;
wherein the sensor measurement comprises a barometric pressure indicator; and
wherein the map comprises a barometric pressure map.

58. The method of claim 53, furthermore:
wherein the sensor comprises an thermometer;
wherein the sensor measurement comprises a temperature; and
wherein the map comprises a thermal map.

59. The method of claim 26, wherein the request for assistance data further comprises a current cell identifier providing service to the mobile device.

60. The method of claim 26, wherein the request for assistance data further comprises a current network identifier providing service to the mobile device.

61. The method of claim 26, wherein the request for assistance data further comprises a type of data service provided to the mobile device.

62. The method of claim 26, wherein the request for assistance data further comprises an address of a data server the mobile device was interacting with.

63. The method of claim 26, wherein the request for assistance data further comprises an address of a streaming service provided to the mobile device.

64. A mobile device comprising a processor and memory, a sensor, a positioning receiver, a cellular transceiver, each coupled to the processor, wherein the memory comprises code for:
receiving positioning signals from the positioning receiver;
computing, in the processor, the estimated position of a location based on the positioning signals;
recording, to the memory, a measurement at the location;
saving the position estimate and the measurement to the memory as an information pair; and
sending, with the cellular transceiver, a request for assistance data, wherein the request for assistance data comprises the position estimate and the measurement.

65. A mobile device, the device comprising:
means for receiving positioning signals;
means for computing the estimated position of a location based on the positioning signals;
means for recording a measurement at the location;
means for saving the position estimate and the measurement to memory; and
means for sending a request for assistance data, wherein the request for assistance data comprises the position estimate and the measurement.

66. A computer-readable storage medium including non-transitory program code stored thereon, comprising program code for:
receiving positioning signals;
computing the estimated position of a location based on the positioning signals;
recording a measurement at the location;
saving the position estimate and the measurement to memory; and
sending a request for assistance data, wherein the request for assistance data comprises the position estimate and the measurement.

67. A server for collecting measurements and estimated positions as information pairs from a plurality of mobile devices operating in at least one mobile radio network, the server comprising, for each mobile device:
means for receiving a request for assistance data comprising a position estimate of a location and a measurement at the location; and
means for saving the position estimate and the measurement as an information pair to a database.

68. The server of claim 67, further comprising:
means for retrieving the information pair for each mobile device from the database as pairs; and
means for compiling a map based on the information pairs.

69. A server comprising a processor and memory coupled to the processor, wherein the memory comprises code for:
receiving a request for assistance data comprising a position estimate of a location and a measurement at the location; and
saving the position estimate and the measurement as an information pair to a database.

70. The server of claim 69, further comprising code for:
retrieving the information pair for each mobile device from the database as pairs; and
compiling a map based on the information pairs.

71. A computer-readable storage medium including non-transitory program code stored thereon, comprising program code for:
receiving a request for assistance data comprising a position estimate of a location and a measurement at the location; and
saving the position estimate and the measurement as an information pair to a database.

72. The computer-readable storage medium of claim 71, further comprising program code for:
retrieving the information pair for each mobile device from the database as pairs; and
compiling a map based on the information pairs.
